(19) United States
(12) Patent Application Publication
(10) Pub. No.: US 2026/0119270 A1
(43) Pub. Date: Apr. 30, 2026

(54) DYNAMIC AUTO-SCALING IN A CLOUD ENVIRONMENT

(71) Applicant: International Business Machines Corporation, Armonk, NY (US)

(72) Inventors: Sean Rory Thornton, San Marcos, TX (US); Josh Galindo, Austin, TX (US); Devon E. Mensching, Austin, TX (US); Charles James Stocker, IV, Plainsboro, NJ (US)

(21) Appl. No.: 18/929,719

(22) Filed: Oct. 29, 2024

(51) Int. Cl. G06F 9/50; G06F 11/34

(52) U.S. Cl. CPC G06F 9/5077; G06F 9/505; G06F 11/3433; G06F 2209/5022; G06F 2209/506

(57) ABSTRACT

Examples described herein provide systems and methods for dynamic auto-scaling a workload deployed in a cloud environment. Aspects include obtaining an auto-scaling policy for the workload, monitoring one or more performance metrics of virtual machines that are executing the workload, and determining that a scaling action is required based on a comparison between the one or more performance metrics to thresholds specified in the auto-scaling policy. Aspects also include obtaining a cost associated with each of a plurality of available scaling options, selecting one of the plurality of available scaling options based on the cost associated with each of a plurality of available scaling options and the auto-scaling policy, and performing the one of the plurality of available scaling options.

### BACKGROUND

The discourse generally relates to cloud computing technologies, specifically to dynamic auto-scaling methods based on cost analysis for cloud environments.

Managing costs associated with cloud services presents a significant challenge for customers. Existing auto-scaling solutions primarily focus on meeting computing needs by either scaling out, which involves adding more virtual machines (VMs), or scaling up, which involves upgrading the capabilities of existing VMs. However, these solutions often fail to consider cost-effective strategies that balance the two approaches.

In a cloud environment, scaling out typically involves provisioning additional VMs to handle increased load, while scaling up involves enhancing the resources (such as CPU, memory, or storage) of existing VMs. Both methods aim to ensure that applications continue to perform optimally under varying loads. However, the costs associated with these methods can fluctuate based on resource availability within data centers. For instance, provisioning short-lived or transient resources, such as Spot Instances, can be more economical for handling temporary demand spikes.

### SUMMARY

According to one aspect of the present invention, a computer-implemented method for dynamic auto-scaling of a workload deployed in a cloud environment is provided. The method involves obtaining an auto-scaling policy for the workload, monitoring one or more performance metrics of virtual machines executing the workload, and determining that a scaling action is required based on a comparison between the performance metrics and thresholds specified in the auto-scaling policy. The method further includes obtaining a cost associated with each of a plurality of available scaling options, selecting one of the scaling options based on the cost and the auto-scaling policy, and performing the selected scaling option.

The above features and advantages, and other features and advantages, of the disclosure, are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of a system for dynamic auto-scaling in a cloud environment, according to one or more embodiments; and

FIG. 3 illustrates a flow chart diagram of a method for dynamic auto-scaling in cloud environments, according to one or more embodiments.

The detailed description explains embodiments of the disclosure, together with advantages and features, by way of example with reference to the drawings.

### DETAILED DESCRIPTION

Cloud computing accounts for significant costs to cloud customers. Auto-scaling services manage costs while providing necessary computing capabilities. However, existing auto-scaling solutions primarily focus on meeting computing needs by either scaling out, which involves adding more virtual machines (VMs), or scaling up, which involves upgrading the capabilities of existing VMs. These solutions often fail to consider cost-effective strategies that balance the two approaches. In a cloud environment, scaling out typically involves provisioning additional VMs to handle increased load, while scaling up involves enhancing the resources (such as CPU, memory, or storage) of existing VMs. Both methods aim to ensure that applications continue to perform optimally under varying loads. However, the costs associated with these methods can fluctuate based on resource availability within data centers. For instance, provisioning short-lived or transient resources, such as Spot Instances, can be more economical for handling temporary demand spikes.

Current auto-scaling methods do not dynamically adjust based on cost analysis to provision or upgrade the most economical resources within data centers. They often rely on predefined policies that do not account for the nuances of variable cloud resource costs. This can lead to suboptimal cost management, where customers may end up paying more for cloud resources than necessary. Therefore, there is a need for a dynamic auto-scaling solution that incorporates cost analysis to make more informed and economical scaling decisions in a hybrid cloud environment.

This disclosure describes a method for dynamic auto-scaling based on cost analysis, which addresses the limitations of existing solutions. The method utilizes historical data and budgetary constraints to make scaling decisions that balance the cost of new cloud resources being provisioned in a plurality of cloud environments. The method determines if scaling up a customer's existing cloud resources is more cost-efficient instead of creating additional cloud resources while still delivering the same performance the customer needs at that time. This approach accounts for the variable cost of cloud resources from modern cloud providers and is particularly beneficial for hybrid cloud solutions, leveraging a combination of multiple cloud providers as well as on-premises resources.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

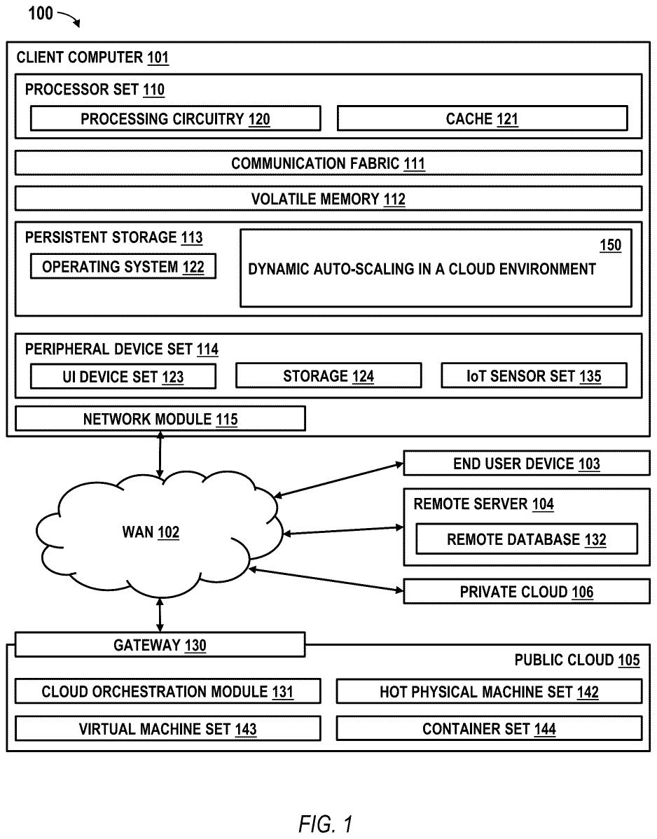

FIG. 1 illustrates a computing environment 100, according to an embodiment. Computing environment 100 contains an example of an environment for the execution of at least some of the computer code involved dynamic auto-scaling in a cloud environment, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output1 ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

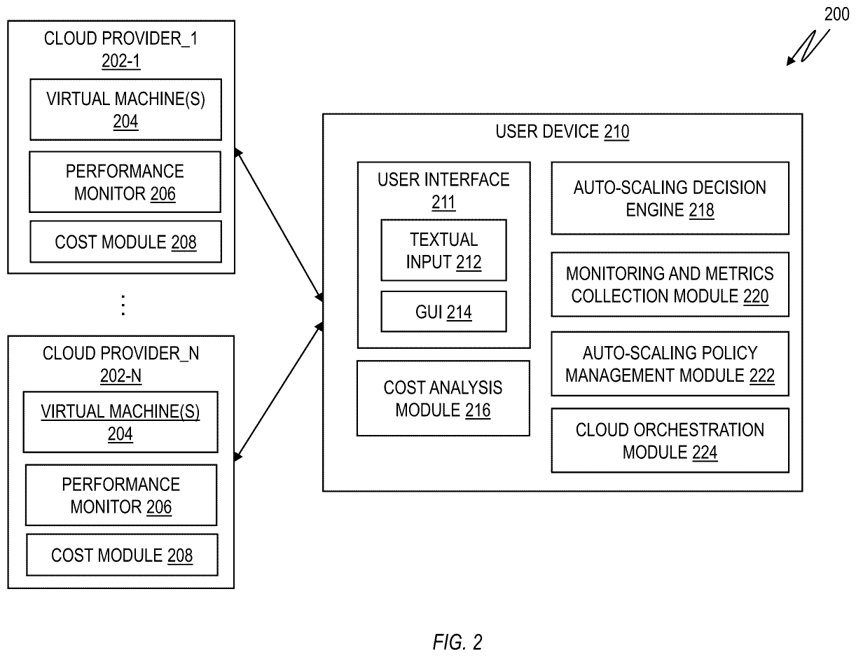

Referring now to FIG. 2, a block diagram of a system 200 for dynamic auto-scaling in a cloud environment is provided. The system 200 includes several components that work together to perform dynamic auto-scaling based at least in part on a cost analysis. In exemplary embodiments, the system 200 includes a user device 210 that is in communication with one or more cloud providers 202. The user device 210 may be a client computer 101 such as the one shown in FIG. 1.

Cloud Provider_1 202-1 and Cloud Provider_N 202-N represent multiple cloud providers that the system 200 can interact with. Each cloud provider 202 includes virtual machine(s) 204, performance monitor 206, and cost module 208. In exemplary embodiments, the virtual machine(s) 204 are the computing resources that can be provisioned or upgraded based on the auto-scaling decisions. In exemplary embodiments, the performance monitor 206 tracks the performance metrics of the virtual machine(s) 204, such as processor usage, memory usage, and network throughput.

In exemplary embodiments, the cost module 208 provides real-time cost data for the virtual machine(s) 204, which is used by the system 200 to make cost-effective scaling decisions. The real-time cost data for the virtual machine(s) 204, which is used by the system 200 to make cost-effective scaling decisions, can vary based on several factors. In one embodiment, the cost of a virtual machine can differ significantly depending on its capabilities, such as processing power, available memory, and storage capacity. For instance, a VM with higher CPU cores, greater memory, and larger storage will generally cost more than a VM with lower specifications. The system 200 takes these variations into account to determine the most cost-effective option that meets the performance requirements of the customer. In another embodiment, the geographical location of the servers that support the virtual machines can also impact the cost. Data centers in different regions may have varying operational costs, which can be reflected in the pricing of the VMs. For example, a VM hosted in a data center located in a region with lower electricity and cooling costs may be cheaper than a VM hosted in a region with higher operational expenses. Additionally, data transfer costs between regions can also affect the overall cost. The system 200 considers these location-based cost differences when making scaling decisions. In a further embodiment, the real-time demand that each cloud provider is experiencing can cause fluctuations in the cost of virtual machines. During periods of high demand, the cost of provisioning new VMs or upgrading existing ones may increase due to limited resource availability. Conversely, during periods of low demand, cloud providers may offer discounts or lower prices to attract customers. The system 200 continuously monitors the real-time demand and adjusts its scaling decisions accordingly to take advantage of lower costs when possible. By analyzing these factors, the cost module 208 provides real-time cost data that reflects the current market conditions and resource availability. The cost analysis module 216 then evaluates this data to recommend the most economical scaling options, ensuring that the auto-scaling decision engine 218 can make informed decisions that optimize both performance and cost.

In exemplary embodiments, the user device 210 includes a user interface 211, which can be a graphical user interface (GUI) 214 or a textual input interface 212. The user interface 211 allows the user to interact with the system 200, define cloud resource configurations, and set scaling policies. The textual input interface 212 enables users to input configurations and policies using text commands, while the GUI 214 provides a more visual and interactive way to define these settings.

In exemplary embodiments, the cost analysis module 216 is responsible for obtaining and analyzing the cost data provided by the cost module 208 of each cloud provider 202. The cost analysis module 216 evaluates the cost-effectiveness of different scaling options, such as scaling out by adding new virtual machine(s) 204 or scaling up by upgrading existing virtual machine(s) 204. In exemplary embodiments, the analysis considers historical data and budgetary constraints to recommend the most economical scaling decisions.

In exemplary embodiments, the auto-scaling decision engine 218 uses the cost analysis results from the cost analysis module 216 to make real-time scaling decisions. The auto-scaling decision engine 218 determines whether to provision new virtual machine(s) 204, upgrade existing virtual machine(s) 204, or de-provision resources based on the current demand and cost-effectiveness. The decisions are made dynamically to ensure optimal performance and cost management.

In exemplary embodiments, the auto-scaling decision engine 218 is configured to make cost-based cloud scaling determinations based on monitored performance metrics received from the monitoring and metrics collection module 220, the cost data received from the cost analysis module 216, and a scaling policy. In exemplary embodiments, the monitoring and metrics collection module 220 continuously monitors the performance metrics of the virtual machine(s) 204, such as CPU usage, memory usage, and network throughput. These metrics are collected by the monitoring and metrics collection module 220 from a performance monitor 206 of each cloud provider 202. The auto-scaling decision engine 218 compares these real-time performance metrics to predefined thresholds specified in the auto-scaling policies. For example, if the CPU usage of a VM consistently exceeds a certain threshold, it indicates that the current resources are insufficient to handle the load, triggering the need for scaling.

Once the auto-scaling decision engine 218 identifies that a scaling action is required based on the performance metrics, it proceeds to evaluate the cost of the available scaling options. The cost analysis module 216 obtains real-time cost data for various scaling options, such as adding new VMs (scaling out) or upgrading existing VMs (scaling up). The auto-scaling decision engine 218 considers the cost-effectiveness of each option while ensuring that the selected option meets the desired performance metrics. For instance, if the CPU usage threshold is exceeded, the decision engine may evaluate the cost of provisioning additional VMs with similar specifications versus upgrading the existing VMs with more CPU cores. The auto-scaling decision engine 218 takes into account factors such as the capabilities of the VMs, the geographical location of the data centers, and the real-time demand and pricing fluctuations from the cloud providers. By comparing these factors, the decision engine selects the most economical option that satisfies the performance requirements.

In exemplary embodiments, the auto-scaling policy management module 222 allows users to define and manage auto-scaling policies. Users can specify conditions under which scaling actions are taken, such as thresholds for CPU usage or memory usage. The policies can be defined through the user interface 211 and are stored in the auto-scaling policy management module 222 for use by the auto-scaling decision engine 218. In exemplary embodiments, the auto-scaling policy defines the conditions under which scaling actions are taken and provides guidelines for balancing cost against performance metrics. For example, a policy might specify that if CPU usage exceeds 80% for more than 5 minutes, additional virtual machines (VMs) should be provisioned. Similarly, if memory usage exceeds 75%, the system should consider scaling up the existing VMs. The policy outlines the specific actions to be taken when performance thresholds are met, such as scaling out by adding new VMs, scaling up by upgrading existing VMs, or scaling in by de-provisioning underutilized resources. For instance, the policy might state that if network throughput exceeds a certain limit, additional VMs with higher network capacity should be provisioned.

In exemplary embodiments, users can define budgetary limits within the auto-scaling policy, including setting a maximum budget for cloud resources over a specific period, such as a monthly budget cap. The auto-scaling policy can also specify cost preferences, such as prioritizing the use of Spot Instances or transient resources to minimize costs. Users can indicate their preferences for balancing costs against various performance metrics. For example, a user might specify that they are willing to tolerate a slight increase in response time if it results in significant cost savings. Conversely, another user might prioritize performance over cost, indicating that they are willing to incur higher expenses to ensure optimal application performance.

The auto-scaling policy can include preferences for resource allocation, such as favoring certain types of VMs or specific data center locations. For example, a user might prefer to use VMs with higher memory capacity for memory-intensive applications or choose data centers in regions with lower operational costs. The auto-scaling policy can leverage historical data to make more informed scaling decisions, specifying that scaling actions should consider historical usage patterns and trends, such as increased demand during specific times of the day or week. Users can define custom application-specific metrics that the auto-scaling policy should monitor. For example, an e-commerce application might include metrics such as the number of active users or transaction rates, and the auto-scaling policy can specify scaling actions based on these custom metrics. By incorporating these elements, an auto-scaling policy provides a comprehensive framework for managing cloud resources dynamically. It ensures that scaling actions are taken based on real-time performance metrics while considering cost constraints and user preferences for balancing cost and performance.

In exemplary embodiments, the cloud orchestration module 224 coordinates the provisioning and de-provisioning of cloud resources across multiple cloud providers 202. The cloud orchestration module 224 ensures that the scaling actions decided by the auto-scaling decision engine 218 are executed efficiently and effectively. The cloud orchestration module 224 manages the deployment of new virtual machine(s) 204, upgrades to existing virtual machine(s) 204, and the removal of resources that are no longer needed.

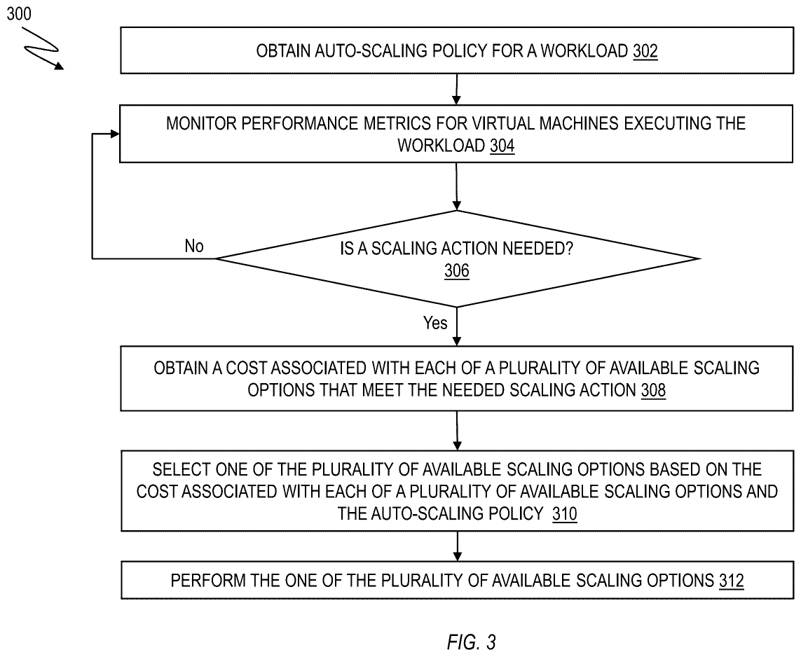

Referring now to FIG. 3, a flowchart diagram of a method 300 for dynamic auto-scaling in cloud environments, according to one or more embodiments is shown. In exemplary embodiments, the method 300 is performed by the user device 210 shown in FIG. 2. The method 300 begins at block 302 by obtaining an auto-scaling policy for a workload. In exemplary embodiments, the auto-scaling policy defines the conditions under which scaling actions are taken, including performance thresholds and budgetary constraints. The auto-scaling policy can be defined by the user through a graphical user interface (GUI) or a textual input interface and stored in the auto-scaling policy management module. In one example, a user defines an auto-scaling policy that specifies if CPU usage exceeds 80% for more than 5 minutes, additional virtual machines (VMs) should be provisioned. The policy also includes a budgetary constraint that limits the monthly expenditure on cloud resources to $10,000.

In exemplary embodiments, the workload is created, or defined by a user, and specifies a configuration of the cloud resources that need to be provisioned by the auto-scaler. For example, the user may define the workload by specifying the type and characteristics of the cloud resources required. This includes selecting the appropriate virtual machine (VM) profiles, such as the number of CPU cores, amount of memory, storage capacity, and network bandwidth. The user may also specify additional configurations, such as the operating system, software stack, and any specific dependencies or libraries needed for the application. In addition, the user may create a template that outlines the desired configuration of the cloud resources. This template can be defined using a graphical user interface (GUI) or a command-line interface (CLI). The template includes detailed specifications for the VMs, such as the instance type, region or data center location, and any specific tags or labels for resource identification and management. Furthermore, the user defines the scaling policies that the auto-scaler will use to manage the resources. Once the workload is defined and the template and scaling policies are created, the auto-scaler uses this information to provision the necessary cloud resources.

As shown at block 304, the method 300 includes monitoring one or more performance metrics for virtual machines executing the workload. In exemplary embodiments, the performance metrics of virtual machines that are executing the workload are continuously monitored. The performance metrics can include, but are not limited to, CPU usage, memory usage, and network throughput. Additional metrics such as disk I/O, latency, and error rates can also be monitored.

Next, as shown at decision block 306, the method 300 includes determining whether a scaling action needed. In this decision step, the auto-scaling system determines whether a scaling action is required based on a comparison between the monitored performance metrics and the thresholds specified in the auto-scaling policy. If the performance metrics exceed the predefined thresholds, a scaling action is needed. In one example, the auto-scaling system detects that the CPU usage of the VMs has exceeded 80% for the past 5 minutes, indicating that the current resources are insufficient to handle the load. Therefore, a scaling action is needed.

In cloud computing, scaling actions are essential for managing the performance and cost-efficiency of applications. There are four primary types of scaling actions: scaling in, scaling out, scaling up, and scaling down. Scaling out, also known as horizontal scaling, involves adding more virtual machines (VMs) or instances to handle increased load. This approach distributes the workload across multiple VMs, enhancing the system's ability to manage higher traffic and ensuring optimal performance. Conversely, scaling in, which is the opposite of scaling out, involves removing VMs or instances when the demand decreases. This action helps in reducing costs by de-provisioning underutilized resources. Scaling up, also known as vertical scaling, involves upgrading the resources of existing VMs, such as increasing CPU, memory, or storage capacity. This method enhances the capabilities of a single VM to handle more significant workloads without adding additional instances. Scaling up is particularly useful for applications that require more powerful individual instances rather than a distributed approach. On the other hand, scaling down involves reducing the resources of existing VMs when the demand decreases. This action helps in optimizing costs by downgrading the capabilities of VMs that are not fully utilized. Each type of scaling action has its advantages and is chosen based on the specific requirements of the application and the current demand. Scaling out and scaling in are typically used for applications that benefit from distributed processing while scaling up and scaling down are suitable for applications that require more robust individual instances.

Next, as shown at decision block 308, the method 300 includes obtaining a cost associated with each of a plurality of available scaling options that meet the needed scaling action. In this step, the auto-scaling system obtains the cost associated with each of a plurality of available scaling options that meet the needed scaling action. The cost data is obtained from the cost module of each cloud provider and includes real-time cost information for various scaling options. In one example, the auto-scaling system queries the cost module of the cloud provider to obtain real-time cost data for adding new VMs (scaling out) and upgrading existing VMs (scaling up). The cost data includes information on the pricing of different VM configurations and the cost variations based on geographical location and resource availability. Conversely, scaling in, which involves removing VMs or instances when the demand decreases, can lead to a potential reduction in costs. By de-provisioning underutilized resources, the system can eliminate the expenses associated with maintaining those VMs. This action helps to optimize costs by ensuring that only the necessary resources are being utilized. Similarly, scaling down, which involves reducing the resources of existing VMs when the demand decreases, can also result in cost savings. Downgrading the capabilities of VMs that are not fully utilized reduces the charges from the cloud provider, as the system is no longer paying for excess capacity. In exemplary embodiments, by obtaining the cost associated with each scaling option, the auto-scaling system can evaluate the cost-effectiveness of different actions. This ensures that the selected scaling option not only meets the desired performance metrics but also adheres to budgetary constraints, optimizing both performance and cost management.

As shown at block 310, the method 300 includes selecting one of the plurality of available scaling options based on the cost associated with each of the plurality of available scaling options and the auto-scaling policy. In this step, the auto-scaling system selects one of the plurality of available scaling options based on the cost associated with each option and the auto-scaling policy. The auto-scaling decision engine evaluates the cost-effectiveness of different scaling options while ensuring that the selected option meets the desired performance metrics. For example, the auto-scaling decision engine compares the cost of provisioning additional VMs with similar specifications versus upgrading the existing VMs with more CPU cores. The auto-scaling decision engine considers factors such as the capabilities of the VMs, the geographical location of the data centers, and the real-time demand and pricing fluctuations from the cloud providers. The decision engine selects the most economical option that satisfies the performance requirements and adheres to the budgetary constraints.

The method 300 concludes at block 312 by performing the one of the plurality of available scaling options. In this step, the auto-scaling system performs the selected scaling option. The cloud orchestration module coordinates the provisioning and de-provisioning of cloud resources across multiple cloud providers, ensuring that the scaling actions are executed efficiently and effectively. For example, the auto-scaling system provisions additional VMs to handle the increased load, as determined by the auto-scaling decision engine. The cloud orchestration module manages the deployment of the new VMs, ensuring that they meet the user's specifications and performance requirements.

In exemplary embodiments, by obtaining an auto-scaling policy for the workload, the system ensures that scaling actions are taken based on predefined conditions, which can include performance thresholds and budgetary constraints. This allows for a more structured and predictable approach to managing cloud resources, ensuring that the system adheres to the user's requirements and financial limitations. Monitoring one or more performance metrics of virtual machines executing the workload allows the system to continuously assess the current state of the resources. This real-time monitoring ensures that any deviations from optimal performance can be quickly identified, enabling timely scaling actions to maintain application performance and reliability. Determining that a scaling action is required based on a comparison between the performance metrics and the thresholds specified in the auto-scaling policy ensures that scaling decisions are data-driven and aligned with the user's predefined criteria. This reduces the risk of over-provisioning or under-provisioning resources, leading to more efficient resource utilization. Obtaining a cost associated with each of a plurality of available scaling options allows the system to evaluate the financial implications of different scaling actions. This cost analysis ensures that the selected scaling option is not only effective in meeting performance requirements but also cost-efficient, optimizing the overall expenditure on cloud resources. Selecting one of the plurality of available scaling options based on the cost associated with each option and the auto-scaling policy ensures that the most economical and effective scaling action is chosen. This decision-making process balances performance needs with cost constraints, providing a more sustainable approach to resource management.

The disclosed systems and methods improve the functioning of a computer by optimizing the allocation and utilization of cloud resources through dynamic auto-scaling based on cost analysis. By continuously monitoring performance metrics and comparing them to predefined thresholds, the system ensures that resources are allocated efficiently, allowing for quick identification of when additional resources are needed or when existing resources can be scaled down. This leads to more effective resource management. Additionally, the system obtains real-time cost data for various scaling options and evaluates the cost-effectiveness of each option. By selecting the most economical scaling actions that meet the desired performance metrics, the system minimizes the overall expenditure on cloud resources, ensuring that the computer operates within budgetary constraints while maintaining optimal performance.

The auto-scaling decision engine dynamically adjusts the cloud resources based on current demand and cost analysis, helping to maintain optimal application performance by ensuring that sufficient resources are available to handle varying workloads. This dynamic adjustment reduces the risk of latency and downtime, ensuring that applications continue to perform optimally and provide a better user experience. The system automates the decision-making process for scaling actions, reducing the need for manual intervention and streamlining the management of cloud resources. This automation allows the computer to operate more efficiently and respond quickly to changes in workload and resource availability. Furthermore, the invention supports both horizontal and vertical scaling, allowing the computer to adapt to different types of workloads and performance requirements. This scalability ensures that the computer can handle varying levels of demand, from small-scale applications to large-scale enterprise workloads. Overall, this invention enhances the functioning of a computer by providing a dynamic, cost-effective, and automated approach to managing cloud resources, ensuring optimal performance, reducing costs, and improving the reliability and efficiency of the computer system.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for dynamic auto-scaling a workload deployed in a cloud environment, the method comprising:
obtaining an auto-scaling policy for the workload;
monitoring one or more performance metrics of virtual machines that are executing the workload;
determining that a scaling action is required based on a comparison between the one or more performance metrics to thresholds specified in the auto-scaling policy;
obtaining a cost associated with each of a plurality of available scaling options;
selecting one of the plurality of available scaling options based on the cost associated with each of a plurality of available scaling options and the auto-scaling policy; and
performing the one of the plurality of available scaling options.

2. The method of claim 1, wherein the one or more performance metrics include CPU usage, memory usage, and network throughput.

3. The method of claim 2, further comprising monitoring additional performance metrics including disk I/O, latency, and error rates.

4. The method of claim 1, wherein the cost associated with each of the plurality of available scaling options is obtained from a cost module of each cloud provider.

5. The method of claim 4, wherein the cost module provides real-time cost data for the virtual machines.

6. The method of claim 1, wherein the plurality of available scaling options include scaling out by adding new virtual machines and scaling up by upgrading existing virtual machines.

7. The method of claim 1, wherein the cloud environment is a hybrid cloud environment that includes multiple different cloud providers.

8. The method of claim 1, wherein the auto-scaling policy includes budgetary constraints for cloud resources utilized by the workload and the budgetary constraints specify a maximum budget for workload over a specific period.

9. A system comprising:
a memory comprising computer readable instructions; and
a processing device for executing the computer readable instructions, the computer readable instructions controlling the processing device to perform operations comprising:
obtaining an auto-scaling policy for a workload in a cloud environment;
monitoring one or more performance metrics of virtual machines that are executing the workload;
determining that a scaling action is required based on a comparison between the one or more performance metrics to thresholds specified in the auto-scaling policy;
obtaining a cost associated with each of a plurality of available scaling options;
selecting one of the plurality of available scaling options based on the cost associated with each of a plurality of available scaling options and the auto-scaling policy; and
performing the one of the plurality of available scaling options.

10. The system of claim 9, wherein the one or more performance metrics include CPU usage, memory usage, and network throughput.

11. The system of claim 10, wherein the operations further comprise monitoring additional performance metrics including disk I/O, latency, and error rates.

12. The system of claim 9, wherein the cost associated with each of the plurality of available scaling options is obtained from a cost module of each cloud provider.

13. The system of claim 12, wherein the cost module provides real-time cost data for the virtual machines.

14. The system of claim 9, wherein the plurality of available scaling options include scaling out by adding new virtual machines and scaling up by upgrading existing virtual machines.

15. The system of claim 9, wherein the cloud environment is a hybrid cloud environment that includes multiple different cloud providers.

16. The system of claim 9, wherein the auto-scaling policy includes budgetary constraints for cloud resources utilized by the workload and the budgetary constraints specify a maximum budget for workload over a specific period.

17. A computer program product for dynamic auto-scaling a workload deployed in a cloud environment, the computer program product comprising:
a set of one or more computer-readable storage media;
program instructions, collectively stored in the set of one or more storage media, for causing a processor set to perform the following computer operations:
obtaining an auto-scaling policy for the workload;
monitoring one or more performance metrics of virtual machines that are executing the workload;
determining that a scaling action is required based on a comparison between the one or more performance metrics to thresholds specified in the auto-scaling policy;
obtaining a cost associated with each of a plurality of available scaling options;
selecting one of the plurality of available scaling options based on the cost associated with each of a plurality of available scaling options and the auto-scaling policy; and
performing the one of the plurality of available scaling options.

18. The computer program product of claim 17, wherein the one or more performance metrics include CPU usage, memory usage, and network throughput.

19. The computer program product of claim 18, wherein the operations further comprise monitoring additional performance metrics including disk I/O, latency, and error rates.

20. The computer program product of claim 17, wherein the cost associated with each of the plurality of available scaling options is obtained from a cost module of each cloud provider.
